(19) United States
(12) Patent Application Publication
(10) Pub. No.: US 2025/0335033 A1
(43) Pub. Date: Oct. 30, 2025

(54) METHODS AND SYSTEMS FOR TOUCHSCREEN BASED HAPTIC CONTROLLER

(71) Applicant: Toyota Research Institute, Inc., Los Altos, CA (US)

(72) Inventors: Scott Carter, San Jose, CA (US); Monica PhuongThao Van, San Leandro, CA (US); Jonathan Yao, San Jose, CA (US); Alexandre L.S. Filipowicz, Mountain View, CA (US)

(73) Assignees: Toyota Research Institute, Inc., Los Altos, CA (US); Toyota Jidosha Kabushiki Kaisha, Aichi-ken (JP)

(21) Appl. No.: 18/651,075

(22) Filed: Apr. 30, 2024

(51) Int. Cl. G06F 3/01; G06F 3/04842; G06F 3/04845; G06F 3/0488

(52) U.S. Cl. CPC G06F 3/016; G06F 3/04842; G06F 3/04845; G06F 3/0488

(57) ABSTRACT

Examples of systems and methods for a haptic controller include a touchscreen including a touchscreen surface, a stencil including one or more openings having customized shapes, and one or more processors. Each customized shape is associated with one of the one or more preloaded shapes. The stencil is attached to the touchscreen surface. The one or more processors are operable to detect a touch event with one of one or more registered interactors on the touchscreen surface, and operate the touchscreen according to the touch event and the one of the one or more registered interactors. Each registered interaction is associated with one of the one or more preloaded shapes.

### TECHNICAL FIELD

The present disclosure relates to electronic display screen, and more particularly, to haptic technology implanted electronic display screen.

### BACKGROUND

Touchscreen technology allows both input and output device integrated into one. A touchscreen relies on visual attention for a user to input and control the device. However, a user does not receive tactile feedback when using a touchscreen device. Rather, the user must use his or her vision to confirm selections have been made on the touchscreen device. Accordingly, there is a need for alternative touchscreen technologies to provide feedback beyond visual feedback alone.

### SUMMARY

In a first aspect, a system for a haptic controller includes a touchscreen including a touchscreen surface, a stencil including one or more openings having customized shapes, and one or more processors. Each customized shape is associated with one of the one or more preloaded shapes. The stencil is attached to the touchscreen surface. The one or more processors are operable to detect a touch event with one of one or more registered interactors on the touchscreen surface, and operate the touchscreen according to the touch event and the one of the one or more registered interactors. Each registered interaction is associated with one of the one or more preloaded shapes.

In a second aspect, a method for a haptic controller includes matching a customized shape of one of one or more openings against one or more preloaded shapes on a stencil-attached touchscreen surface of a touchscreen to register an interactor associated with one of the one or more preloaded shapes that matches the customized shape, detecting a touch event with the registered interactors, and operating according to the touch event and the registered interactors. The stencil includes the one or more openings having one or more customized shapes.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example tactile touchscreen system for a haptic controller, according to one or more embodiments shown and described herein;

FIG. 2 schematically depicts non-limiting components of an example touchscreen of the tactile touchscreen system, according to one or more embodiments shown and described herein;

FIG. 3A schematically depicts an example tactile touchscreen system including two touchscreens for pairing, according to one or more embodiments shown and described herein;

FIG. 3B schematically depicts an example tactile touchscreen system including two touchscreens for operation, according to one or more embodiments shown and described herein;

FIG. 4A schematically depicts an example tactile touchscreen system for the haptic controller for indicator registration of a bar-shape opening, according to one or more embodiments shown and described herein;

FIG. 4B schematically depicts an example tactile touchscreen system for the haptic controller for finished indicator registration of a bar-shape opening, according to one or more embodiments shown and described herein;

FIG. 5A schematically depicts an example tactile touchscreen system for the haptic controller for indicator registration of a ring-shape opening corresponding to the ring shape, according to one or more embodiments shown and described herein;

FIG. 5B schematically depicts an example tactile touchscreen system for the haptic controller for a registered ring-shape indicator corresponding to controlling a vehicle, according to one or more embodiments shown and described herein;

FIG. 6 schematically depicts an example tactile touchscreen system for the haptic controller with registered indicators, according to one or more embodiments shown and described herein;

FIG. 7 illustrates a flow diagram of illustrative preparation steps for the touchscreen-based haptic controller, according to one or more embodiments shown and described herein;

FIG. 8 illustrates a flow diagram of illustrative registration steps for the touchscreen-based haptic controller, according to one or more embodiments shown and described herein; and

FIG. 9 illustrates a flow diagram of illustrative deployment steps for the touchscreen-based haptic controller, according to one or more embodiments shown and described herein.

### DETAILED DESCRIPTION

The embodiments described herein are directed to systems and methods of selectively masked touchscreens for tactile interactions. The mask may be a stencil, featured with one or more openings having customized shapes such that once attached to a touchscreen surface, a user may contact the touchscreen surface through these openings to operate and control the system. The systems and methods may register one or more interactors associated with the customized shape of each opening, recognize and respond to the user's touch or contact with the interactors as a touch event, and further provide feedback and actions following the touch event. Once the interactors are registered, the system may automatically recognize, relocate, or resize the interactors based on a detected touch event. During operation, a user may sense the opening without taking a look at the touchscreen, and perform various touch events relying on the touch sense to the customized shapes of the openings.

The disclosed systems and methods thus allow users to interact with the touchscreen using their sense of touch in addition to or independent from their visual feedback, providing the benefit for individuals with visual impairments or in situations where visual attention is limited or undesired. By incorporating tactile feedback, users can navigate and interact with touchscreen devices independently of visual cues, enhancing accessibility and inclusivity. This tactile sensation not only provides discreet interaction but also reduces cognitive load, particularly in environments where multitasking or visual distractions are prevalent. Additionally, tactile feedback enables users to maintain focus on their surroundings, improving safety in contexts such as driving or operating machinery.

The systems may preload different shapes corresponding to the openings to allow for customization of the interaction interface. Users can choose or customize the shape of the openings based on their preferences or specific needs. Additionally, the background program can recognize these shapes and associate them with specific touch interactions, providing a more intuitive and personalized user experience. The systems and methods enhance the touchscreen experience by providing an inclusive and versatile interaction approach with customizable interfaces.

In some embodiments, the stencil may be removably attached to the touchscreen through mechanical engagement, while in some other embodiments, the stencil may be adhered to the touchscreen through adhesive attachment. The flexible approach to customizing the stencil provides robust compatibility of the stencil to be used on readily available touchscreens.

As used herein, whenever possible, the same reference numerals will be used throughout the drawings to refer to the same or like parts. The singular forms “a,” “an” and “the” include plural referents unless the context clearly dictates otherwise. Thus, for example, reference to “a” component includes aspects having two or more such components unless the context clearly indicates otherwise.

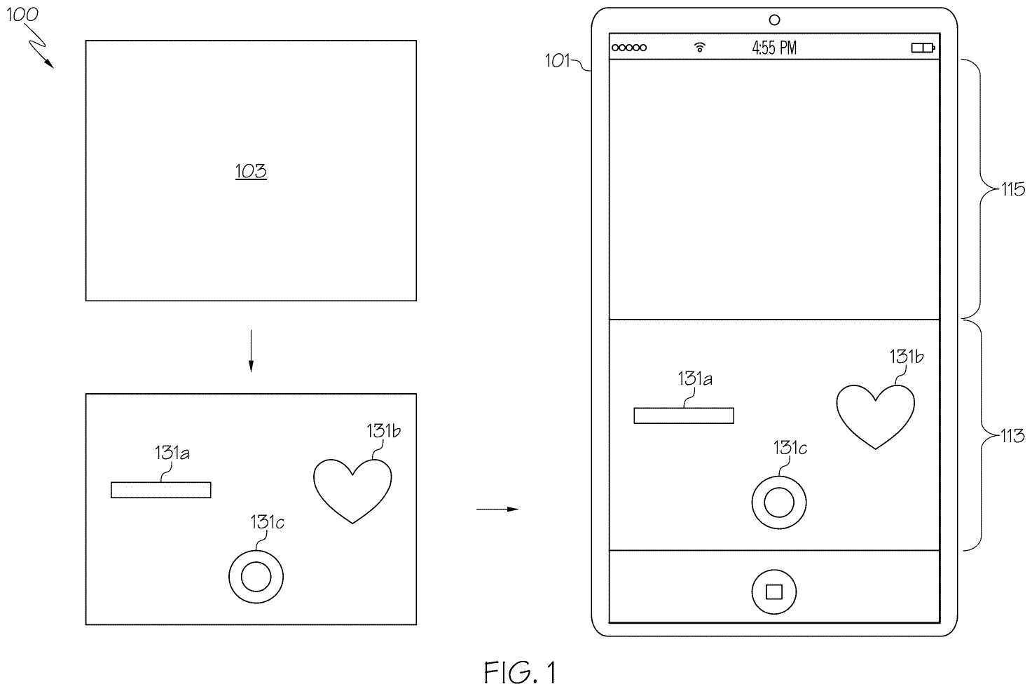

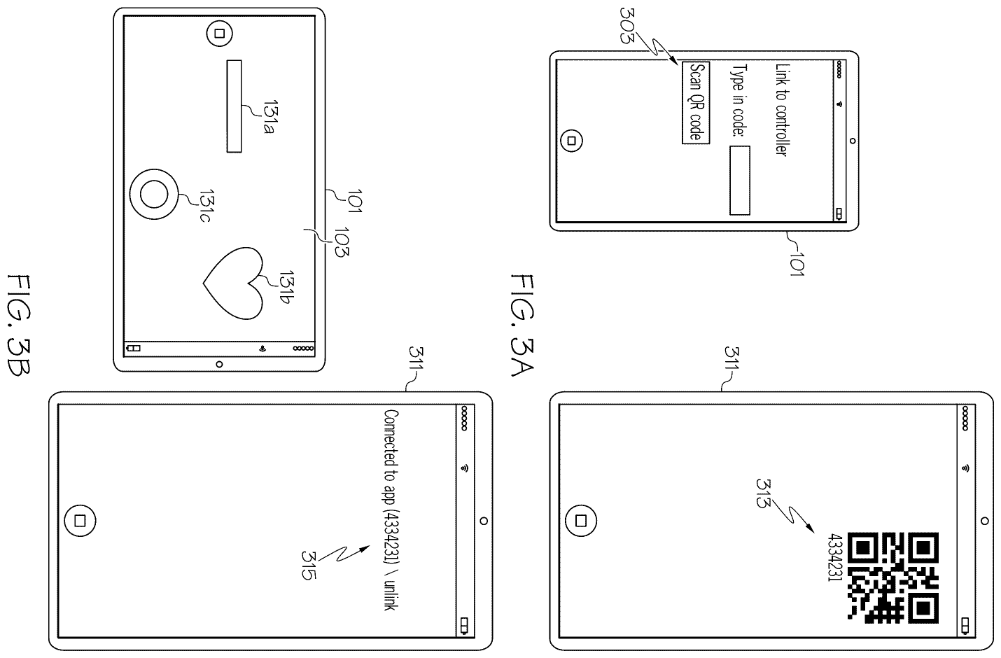

Turning to figures, FIGS. 1 and 3A-3B generally depict the tactile touchscreen system 100 for a haptic controller application. The tactile touchscreen system 100 for the haptic controller application includes one or more touchscreens 101 and 311, and one or more stencils 103. In some embodiments, the touchscreen 101 may include an App region 113 and a controller region 115 on a touchscreen surface of a single touchscreen 101. The stencil 103 may be operably attached to the App region 113 to generate interactors, and the controller region 115 is configured to perform interactions with a user independent from the stencil 103. In some other embodiments, the touchscreens 101 may include two or more touchscreens, with at least one touchscreen 101 as an App touchscreen 101 and a controller touchscreen 311 (e.g., as illustrated in FIGS. 3A and 3B). The stencils 103 may be a mask including one or more openings 131, such as a bar-shape opening 131a, a heart-shape opening 131b, and a ring-shape opening 131c. A user may interact with the tactile touchscreen system 100 and the touchscreen 101. The user may be a natural person, a robot, or a tangible object.

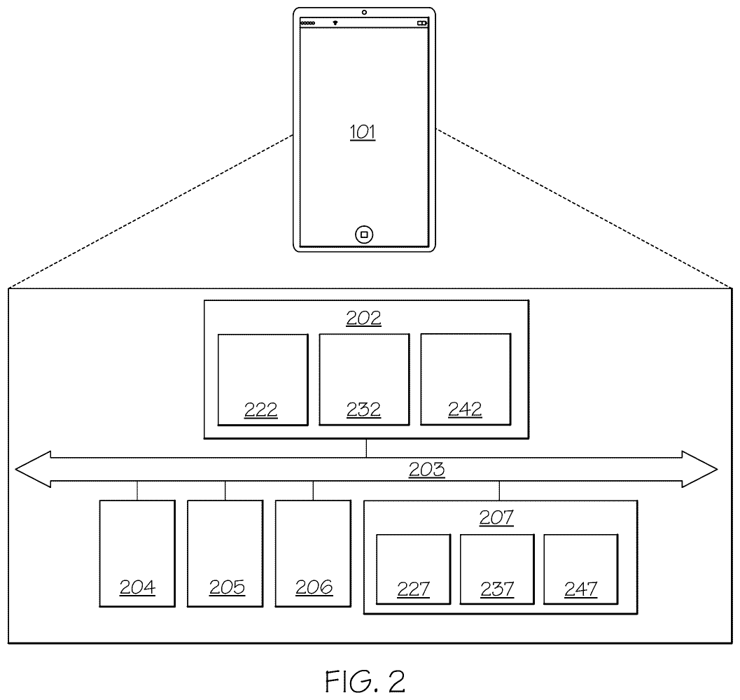

In embodiments, the touchscreen 101 may be an electronic display that enables users to interact directly with electronic devices by touching the touchscreen surface with their fingers or a stylus. The touchscreen 101 may be, without limitation, a computer, a laptop, a cell phone, a smartphone, a tablet, or a wearable device such as a smartwatch or fitness tracker. The touchscreen 101 may be a resistive touchscreen that utilizes multiple layers of flexible material that generate a circuit when pressure is applied, allowing for touch detection. The touchscreen 101 may be a capacitive touchscreen, relying on the electrical properties of the human body to detect touch, using a transparent conductor coating on a glass panel. The touchscreen 101 may be a Surface Acoustic Wave (SAW) touchscreen, an Infrared (IR) touchscreen, or a touchscreen of another type that allows the user to interact with the touchscreen by touching the touchscreen surface. The touchscreen 101 may include multiple layers including a cover glass or surface material for protection, a touch sensor layer for detecting touch input using technologies like capacitive or resistive sensors, one or more processors 204 (e.g. as illustrated in FIG. 2) for processing touch signals and communicating with the device's operating system, a display panel for generating visual output based on user interactions, and optional components like backlighting or additional layers for functionalities such as durability enhancement or electromagnetic interference shielding. These components may be housed within a supporting structure like a frame or bezel, creating a cohesive unit that allows users to interact directly with digital content through intuitive touch gestures.

In embodiments, the stencil 103 may be a film or a board made of, without limitation, polymers, plastic, rubber, silicone sheets, leather, non-conductive films or sheets. For example, the stencil 103 may be, without limitation, a polyethylene terephthalate film, a polyethylene film, a polyvinyl chloride film, an acrylic film, a polycarbonate film, a glass film, or a combination thereof. The stencil 103 may selectively cover the touchscreen surface of the touchscreen 101. For example, the stencil 103 may be custom-designed to cover some areas of the touchscreen 101, such as the App region 113, and leave other areas, such as the controller area 115, exposed for interactions not based on the openings 131 of the stencil 103. The customized shape of the stencil 103 may correspond to the layout of the touchscreen 101, with openings 131 strategically positioned to align with the interactive regions for the haptic controller application.

In some embodiments, the openings 131 may be created on a raw the stencil 103 through various methods. For example, the openings 131 may be created on a raw stencil 103 using, without limitation, manual cutting, die cutting, laser cutting, computer numerical control milling, chemical etching, waterjet cutting, or cutting or drilling technologies. In some embodiments, the opening 131 may be created simultaneously with the stencil 103 through three-dimensional (3D) printing. The one or more openings 131 may be designed by a user in customized shapes, such as, without limitation, a bar shape, a heart shape, a square shape, a rectangular shape, a ring shape, a circle shape, or other regular or irregular shapes.

In embodiments, the stencil 103 created with one or more openings 131, such as the bar-shape opening 131a, the heart-shape opening 131b, and the ring-shape opening 131c, may be attached to the selected area, e.g., the App region 113, of the touchscreen surface of the touchscreen 101. The stencil 103 may have a border that is equal to or larger than a detectable width of touchpoints on the controller region 115 or a second touchscreen 311 (e.g. as illustrated in FIGS. 3A and 3B) as a controller. In some embodiments, the stencil 103 may be removably attached to the App region 113 through removable attachments, such as, without limitation, adhesive strips or tape, Velcro strips, magnetic attachments, or mechanical clipping. The removable attachment may result in the stencil 103 being temporarily but securely held in place, which allows for easy removal, replacement, and repositioning of the stencil 103. In some embodiments, the stencil 103 may be adhered to the touchscreen 101 as a permanent attachment. For example, the stencil 103 may be attached to the touchscreen surface of the touchscreen 101 using, without limitation, Epoxy resin, UV-activated adhesives, and heat-activated adhesive, leading to a desired level of permanence.

In some embodiments, the stencil 103 may have a border larger than the detectable width of touchpoints on the controller region 115 or the second touchscreen 311. In operation, this allows a crossing-based interaction to dismiss out-of-date controller region 115. With the stencil 103 in place, if the user wants to move the stencil 103 on the controller region 115 or the second touchscreen 311, the user may take off the stencil 103 from the App region 113 and then swipe across the boundary of the digital representation of the controller region 115 to dismiss the stencil 103. As such, no events could occur in the border of the stencil 103 unless it has been removed. Once a digital controller associated with the previously registered interactors is removed, the touchscreen 101 can begin a new registration process.

In some embodiments, the user may create any contiguous 2D stencil shape (e.g. as a PNG file). The user may send that customized shape to a 3D printer or cutter, or print it on standard paper to use as a guide to cut the customized shape into a material. The material of the stencil 103 can be tacky and non-conductive, capable of attaching temporarily to a capacitive touch surface. It is also possible to apply a substance (e.g., Krylon Easy-Tack Repositionable Adhesive) to any material that will render the stencil 103 tacky and repositionable at least temporarily. With the customized shape cut in relief, the stencil 103 can be placed on the touchscreen surface of the touchscreen 101.

In some embodiments, the tactile touchscreen system 100 may further include a layer of conductive fabrics beneath the stencil 103 to create a three-dimensional (3D) physical controller. The tactile touchscreen system 100 may include a conductive fabric arranged between the stencil 103 and the touchscreen 101. The conductive fabric may include one or more fabric openings near locations of the one or more openings 131. At least partial conductive fabric may be exposed through the one or more openings 131. At least a partial touchscreen surface may be exposed through the one or more fabric openings and the one or more openings 131. The conductive fabric may be configured to detect the touch event. For example, two stencils 103 may be used to create a circular interactor. The lower stencil 103 directly attached to the touchscreen 101 would have a small circular cutout while the higher stencil 103 may have a larger or a wider circular cutout. The conductive fabric may be placed on the annulus formed on the lower stencil 103.

In embodiments, each opening 131 in the stencil 103 may be registered as an interactor. The tactile touchscreen system 100 may be loaded with shape files corresponding to the customized shapes of the openings 131. The tactile touchscreen system 100 may also be loaded with one or more callback functions 227 associated with the preloaded shapes 237 and/or the interactors. For each interactor, the user may specify in the app the interactor's shape file as well as a software callback function 227 to handle touch events generated by the interactor when the user touches the touchscreen surface of the touchscreen 101 through one of the opening 131. In some embodiments, the callback function 227 may not rely on the size of the interactor a priori. Instead, the callback function 227 may employ exclusively relative comparisons of touch events with the registered interactor and associated preload shapes. In some embodiments, the user may supply a text label or an optional label 247 for each interactor.

In embodiments, the controller region 115 or the second touchscreen 311 (as illustrated in FIGS. 3A and 3B) may include, without limitation, input controls, display area, navigation elements, feedback and validation, dialogs and modals, layouts, and other components for the tactile touchscreen system 100 for interactions with a user other than the interactions relying on the stencil 103. In some embodiments, controller region 115 or the second touchscreen 311 may include an input control to provide input to the touchscreen 101, such as, without limitation, text fields, checkboxes, radio buttons, dropdown menus, sliders, buttons, and touch gestures. The controller region 115 or the second touchscreen 311 may further include a display area to present information, feedback, or output to the users, including elements like, without limitation, text, images, icons, charts, graphs, tables, notifications, and status indicators. The controller region 115 or the second touchscreen 311 may also include a navigation element for the user to move through different sections or screens within the controller region 115 or the second touchscreen 311. The navigation element may include, without limitation, menus, tabs, breadcrumbs, sidebars, and hyperlinks. The controller region 115 or the second touchscreen 311 may include feedback and validation to provide the user with information about the outcome of their actions or the current state of the tactile touchscreen system 100. Feedback or validation may include, without limitation, tooltips, error messages, success notifications, progress bars, and validation indicators. The controller region 115 or the second touchscreen 311 may include dialogs and modals as temporary pop-up windows that prompt the user for specific input (e.g. to contact an opening 131 the same shape as displayed), display additional information, or require users to make decisions.

Referring to FIG. 2, non-limiting components of the devices on a touchscreen 101 of the tactile touchscreen system 100 are depicted. The tactile touchscreen system 100 may include one or more touchscreens, such as the touchscreens 101 and 311. Each touchscreen, such as the touchscreen 101 or the second touchscreen 311, may include similar components, modules, and structure as described herein. As such, the descriptions of the touchscreen 101 may apply to the other one or more touchscreens, such as the second touchscreen 311. The touchscreen 101 may comprise a registration module 222, a deployment module 232, and a pairing module 242. The touchscreen 101 may comprise various components, such as a memory component 202, a processor 204, an input/output hardware 205, a network interface hardware 206, a data storage component 207, and a local interface 203.

The touchscreen 101 may be any device or combination of components comprising a processor 204 and a memory component 202, such as a non-transitory computer-readable memory. The processor 204 may be any device capable of executing a machine-readable instruction set stored in the non-transitory computer-readable memory. Accordingly, the processor 204 may be an electric controller, an integrated circuit, a microchip, a computer, or any other computing device. The processor 204 may include any processing component(s) configured to receive and execute programming instructions (such as from the data storage component 207 and/or the memory component 202). The instructions may be in the form of a machine-readable instruction set stored in the data storage component 207 and/or the memory component 202. The processor 204 is communicatively coupled to the other components of the touchscreen 101 by the local interface 203. Accordingly, the local interface 203 may communicatively couple any number of processors 204 with one another, and allow the components coupled to the local interface 203 to operate in a distributed computing environment. The local interface 203 may be implemented as a bus or other interface to facilitate communication among the components of the touchscreen 101. In some embodiments, each of the components may operate as a node that may send and/or receive data. While the embodiment depicted in FIG. 2 includes a single processor, other embodiments may include more than one processor.

The memory component 202 (e.g., a non-transitory computer-readable memory component) may comprise RAM, ROM, flash memories, hard drives, or any non-transitory memory device capable of storing machine-readable instructions such that the machine-readable instructions can be accessed and executed by the processor 204. The machine-readable instruction set may comprise logic or algorithm(s) written in any programming language of any generation (e.g., 1GL, 2GL, 3GL, 4GL, or 5GL) such as, for example, machine language that may be directly executed by the processor 204, or assembly language, object-oriented programming (OOP), scripting languages, microcode, etc., that may be compiled or assembled into machine readable instructions and stored in the memory component 202. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. For example, the memory component 202 may be a machine-readable memory (which may also be referred to as a non-transitory processor-readable memory or medium) that stores instructions that, when executed by the processor 204, causes the processor 204 to perform a method or control scheme as described herein. While the embodiment depicted in FIG. 2 includes a single non-transitory computer-readable memory, other embodiments may include more than one memory module.

The input/output hardware 205 may include a monitor, keyboard, mouse, printer, camera, microphone, speaker, and/or other device for receiving, sending, and/or presenting data. The network interface hardware 206 may include any wired or wireless networking hardware, such as a modem, LAN port, Wi-Fi card, WiMax card, mobile communications hardware, and/or other hardware for communicating with other networks and/or devices. The data storage component 207 can store callback functions 227, preloaded shapes 237, and optional labels 247.

Referring to FIGS. 3A and 3B, an example tactile touchscreen system 100 includes two touchscreens, namely the App touchscreen 101 and the second touchscreen/controller touchscreen 311 for operation. The tactile touchscreen system 100 may determine whether the App touchscreen 101 and the controller touchscreen 311 are connected such that the controller touchscreen 311 may respond to the operation of the user on the App touchscreen 101. When the App and the controller are within the same touchscreen 101, such as in FIG. 1, the tactile touchscreen system 100 may automatically find the App and the controller are connected. In some embodiments, as illustrated in FIG. 3A and 3B, the tactile touchscreen system 100 may include a second touchscreen 311 as a controller touchscreen 311, and treat the touchscreen 101 as the App touchscreen. If the app and controller are on different devices, the pairing module 242 may connect the two devices, namely the App touchscreen 101 and the controller touchscreen 311, through pairing. The controller touchscreen 311 may connect to the App touchscreen 101 through a connection of physical or logical link to facilitate data communication. The connections may be, without limitation, a wired connection such as Ethernet, a wireless connection such as WiFi, Bluetooth, near field communication (NFC), cellular connection such as GSM/3G/4G/5G/6G. The connection allows the detected touch activities on the touchscreen 101 to be transmitted from the touchscreen 101 to the second touchscreen 311, or vice versa. The two touchscreens 101 and 311 may be linked using a RTCDataChannel web API or a higher-level wrapper, such as PeerJS [https://peerjs.com/]).

In some embodiments, the pairing may be fulfilled through sharing an identifying code between the touchscreen 101 and the second touchscreen 311. For example, as illustrated in FIG. 3A, pairing module 242 may facilitate connectivity between the two touchscreens via an identifying code. The pairing module 242 may first generate a unique code, typically presented as a readable alphanumeric string or barcode 313, and display on one of the touchscreens, e.g. on the controller touchscreen 311 as in FIG. 3A. This code may be prominently displayed on the second touchscreen/controller touchscreen's 311 interface, awaiting interaction. Meanwhile, the other touchscreen, e.g. the App touchscreen 101 in FIG. 3A, may offer a feature to either directly scan the displayed code using a camera or manually input the code in an input area 303 via an on-screen keyboard. Once the barcode 313 is captured or entered, the barcode 313 may be transmitted to the controller touchscreen 311 for the pairing module's 242 verification. Through a secure process, the pairing module 242 may validate the received code against its generated counterpart. Upon successful matching, both touchscreens 101 and 311 may acknowledge the pairing and establish a connection, allowing for data exchange.

As illustrated in FIG. 3B, after pairing, the App touchscreen 101 and/or controller touchscreen 311 may display a message 315 regarding a successful pairing (e.g. connected to the app (4334231) and may provide an optional to disconnect (e.g. “unlink”). The stencil 103 may then be applied to the touchscreen surface of the app touchscreen 101 for interaction registration and deployment as described herein.

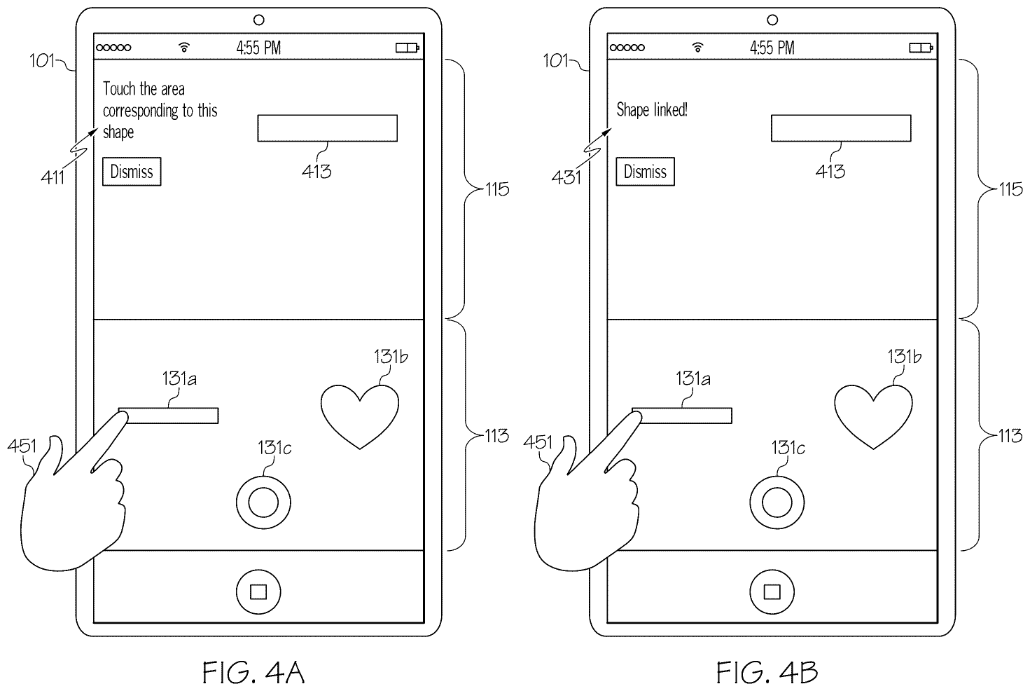

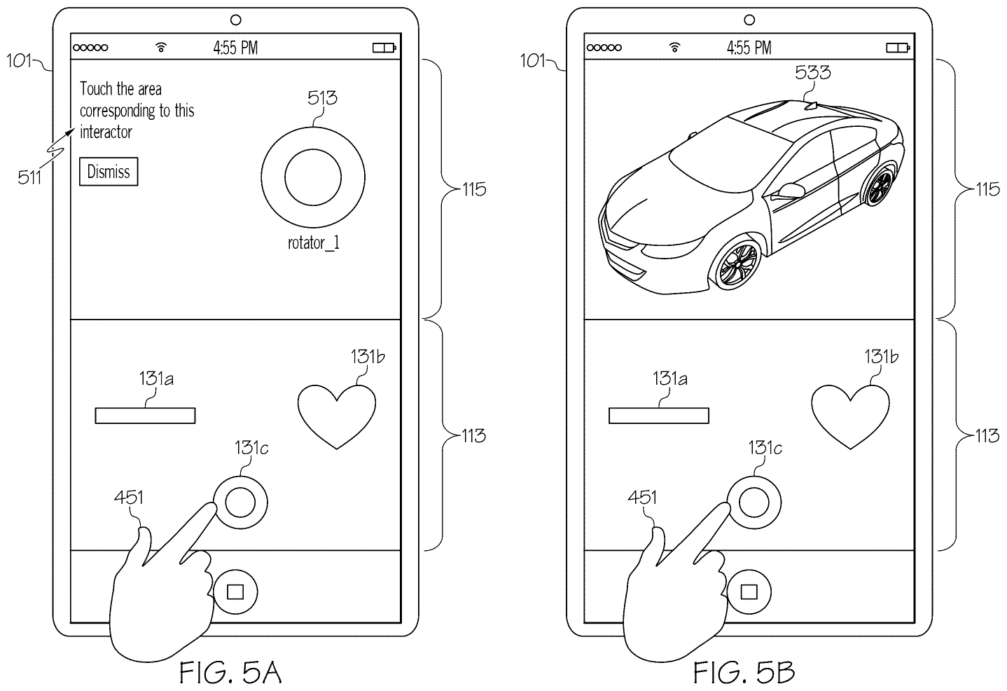

Turning to FIGS. 4A-5B, the indicator registration using the tactile touchscreen system 100 for the haptic controller is depicted. After the system recognizes the App region 113 or App touchscreen 101 and controller region 115 or controller touchscreen 311 of the system 100, e.g. the App region 113 and controller region 115 in one touchscreen 101 as in FIGS. 4A-5B, or the App touchscreen 101 and the Controller touchscreen 311 as in FIGS. 3A-3B, the registration module 222 may direct the user to register one or more interactors associated with the openings 131, such as the bar-shape opening 131a, the heart-shape opening 131b, and the ring-shape opening 131c, through displaying information in the controller region 113 and collect feedback from user interaction through the openings 131 in the App region 113.

For example, FIGS. 4A-4B depict the registration process for a user to register a bar-shape interactor associated with the bar-shape opening 131a. As illustrated in FIG. 4A, the registration module 222 may facilitate user interaction by displaying operation instructions 411 on the app touchscreen 101 (e.g., as illustrated in FIG. 3A and 3B), guiding the user to touch specific areas corresponding to preloaded shapes 237. For instance, a preloaded bar-shape 413 may be displayed in the controller region 115 and the registration module 222 may prompt the user with operation instructions 411 like “touch the area corresponding to this shape” while displaying a preloaded image representing the intended customized shape, such as a bar shape. Additionally, a “Dismiss” button is provided to allow the user to skip the registration process for the current shape if desired. The user can use their hand 451, typically with a finger, to trace the outlines of the corresponding shape opening 131 on the physical stencil 103. As the user interacts, the registration module 222 collects and stores activated pixels, establishing a mapping and match between these activated pixels and the preloaded bar shape 237. Such mapping and matching may include a degree of tolerance to allow shape difference between the activated pixels and the preloaded shapes, due to various introduced errors through the process, such as the shape stray caused by cutting or drilling, attachment, and other possible reasons.

In some embodiments, the registration module 222 may instruct the user to interact with the bar-shape opening 131a in different manners that may serve as input for the callback function 227 responsible for touch event recognition and subsequent operation and response functions. For example, the registration module 222 may provide instructions in the controller region 115 to ask the user to perform different actions, such as swapping the bar-shape opening 131a from left to right, swapping the bar-shape opening 131a from right to left, tapping once, or twice at either end of the opening 131, or performing a long-press gesture at the left or right end. These diverse interactions allow for a range of functionalities to be associated with each action recognized by the callback function 227. For example, swapping the bar shape could correspond to adjusting a parameter value, tapping once might trigger a selection action, tapping twice could initiate a confirmation, while long-pressing might activate a contextual menu or initiate a drag-and-drop operation.

In some embodiments, the registration module 222 may use a scale and rotation invariant matching (SIFT) algorithm to perform the shape matching. This algorithm may determine scale and rotation vectors to map all incoming touch event points to the shapes of the registered interactors, ensuring robust matching regardless of variations in scale or orientation. The SIFT algorithm may facilitate flexible shape matching for user interaction on the tactile touchscreen system 100. Initially, SIFT may detect key points within both the preloaded shape 237 (e.g. the bar shape 131a, the heart shape 131b, or the ring shape 131c) and the collected activated pixels, leveraging local extrema detection in scale space to ensure robustness to variations in shape size. Each key point may be assigned an orientation based on local gradients, enabling rotation invariance. SIFT may then compute descriptors for these key points, encoding their unique appearance characteristics. By comparing descriptors between the preloaded shapes 237 and user-generated touch input, SIFT may identify matches using similarity measures like Euclidean distance, ensuring desirable shape recognition even amidst scale and rotation changes.

As illustrated in FIG. 4B, once the bar-shape interactor is registered, the touchscreen 101 may display a message 431, such as “Shape linked” to indicate the bar-shape opening 131a is registered, such as highlight color around the inner boundary of the bar-shape opening 131a and the preloaded bar-shape 413. The highlight color may remain until all the openings 131 are registered or the registration process is finished. For example, as in FIG. 5A, during the process of registering a ring-shape interactor, the highlight color of the bar-shape opening 131a may remain.

Referring to FIGS. 5A and 5B, the registration process for a user to register a ring-shape interactor associated with the bar-shape opening 131a is depicted. Similar to the registration of the bar-shape interactor as illustrated in FIGS. 4A and 4B, the registration module 222 may facilitate user interaction by displaying operation instructions 511 on the app touchscreen, guiding users to touch specific areas corresponding to the preloaded ring-shape image. For instance, the controller region 115 may display a preloaded ring shape 513 and may prompt users with operation instructions 511 like “touch the area corresponding to this interactor.” The user may skip registering this ring shape by clicking the “Dismiss” button. The interactor shape may include a label name, such as “rotator_1” to disambiguate similar shape designs. Users can use their hand 451, typically with a finger, to trace the outlines of the ring-shape opening 131c on the physical stencil 103. As users interact, the registration module 222 collects and stores activated pixels, establishing a mapping and match between these activated pixels and the preloaded ring-shape image.

In some embodiments, the registration module 222 may instruct the user to interact with the circle-shape opening 131c in different manners that may serve as input for the callback function 227 responsible for touch event recognition and subsequent operation and response functions. For example, the registration module 222 may provide instructions in the controller region 115 to ask the user to perform different actions, such as moving clockwise or counterclockwise. These diverse interactions allow for a range of functionalities to be associated with each action recognized by the callback function 227. For example, moving clockwise and counterclockwise can serve as functions like turning an imagine knob or rotating the vehicle 533 clockwise or counterclockwise.

In some embodiments, the deployment module 232 may operate to detect the touch event with one of the one or more interactors. For example, the deployment module 232 may detect a location and activated pixels of the touch event, and determine whether the activated pixels match with one of the one or more preloaded shapes 237, such as preloaded bar-shape 413 and the preloaded ring shape 513, associated with a corresponding interactor that has a registered location different than the location of the touch event. In determining that the activated pixels match with the one of the one or more preloaded shapes 237, the deployment module 232 may assign a location of the corresponding interactor relative to the location of the touch event and adjust the size of the corresponding interactor relative to the one of the one or more preloaded shapes 237. For example, once registered, the user may use the registered openings 131 as registered interactors to interact with the tactile touchscreen system 100. The user may touch the touchscreen surface through one of the openings 131, such as the bar-shape opening 131a, the heart-shape opening 131b, and the ring-shape opening 131c in a manner as during the registration to trigger one of the corresponding predetermined operations associated with that reiterated interactor and the touch event. For example, a user may use his/her finger to swap the bar-shape opening from left to right. The deployment module 232 may detect the activated pixels during this touch event, and send the activated pixels to the callback function 227. The callback function 227 may recognize the touch event is associated with the registered bar-shape interactor and the touch event is a swap from left to right. The callback function 227 may then turn the display information in the controller region 115 or another display menu to the next option or next page. Similarly, when the user conducts a clockwise touch with the ring-shape opening 131c, the deployment module 232 may send the activated pixel to the callback function 227. The callback function 227 may recognize the touch event is associated with the registered ring-shape interactor and further recognize the touch event is a clockwise touch gesture in corresponding to a rotate operation for the displayed vehicle 533 or other objects in the controller region 115 or another display.

In some embodiments, the customized shapes of the openings 131 can be pre-configured with touch-up actions to trigger different events when the user releases over a region. For example, the user may print a line with rounded corners simulating a toggle region. When the user toggles one direction, the interactor can launch an “on( )” event; when the user toggles the other direction, the interactor can launch an “off( )” event. Furthermore, vibrations may be added to events to help communicate differences in events. For example, the “on( )” event may be configured to pulse 2 rapid vibrations in succession, and an “off( )” event may trigger a single vibration. The vibrations can be added with different API, such as a navigator.vibrate( ) API.

In some embodiments, the deployment module 232 may assign an optional label 247 to each registered interactor. For example, a corresponding unique label may be displayed on the touchscreen 101 within the boundary of each registered opening 131.

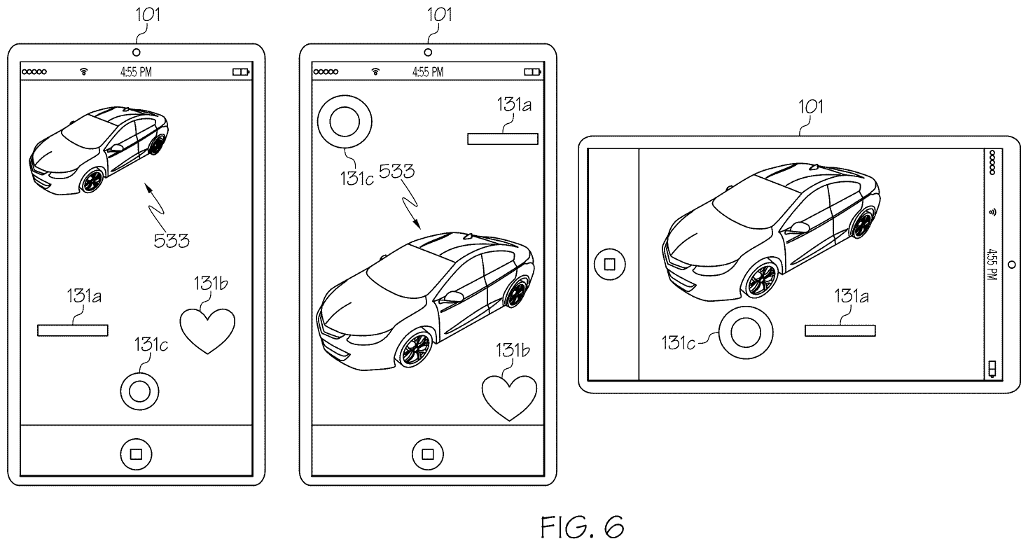

Referring to FIG. 6, relocated openings 131 after registration and interactions with the interactors of the example tactile touchscreen system 100 for the haptic controller are depicted. The deployment module 232 may the system may detect a touch event associated with a registered interactor by aligning and scaling the corresponding preloaded shape 237 with the detected activated pixels, regardless of the location, orientation, and scaling of the detected activated pixels compared with the original registered openings 131. For example, the bar-shape opening 131a and ring-shape opening 131c, as illustrated in FIGS. 4A-5B, are registered at a location and scaling different than the three embodiments as illustrated in FIG. 6. Further, the bar-shape interactor, the heart-shape interactor, and the ring-shape interactor are different in the three embodiments of FIG. 6. The deployment module 232, based on the touch event associated with the activated pixels, may recognize each touch event being related to the bar-shape or the ring-shape interactor and may allow the callback function to further operate the tactile touchscreen system 100 in accordance with the touch event and the preloaded shape 237 of the registered interactor. Accordingly, the vehicle 533 may be operated to be rotated clockwise or counterclockwise using the ring-shape interactor at different locations of the three embodiments in FIG. 6, despite their locations and scale differences.

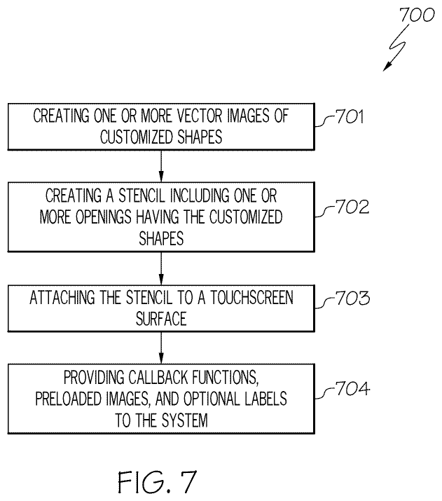

Referring to FIG. 7, an example flow diagram of illustrative preparation steps for the touchscreen-based haptic controller is illustrated. At block 701, the method 700 of preparation for the haptic controller based on a touchscreen may include creating one or more vector images of customized shapes. At block 702, the method 700 of preparation may include creating a stencil 103 including one or more openings having the customized shapes 237. At block 703, the method 700 of preparation may include attaching the stencil 103 to a touchscreen surface. At block 704, the method 700 of preparation may include provide callback functions, preloaded shapes 237, and optional labels 247 to the tactile touchscreen system 100.

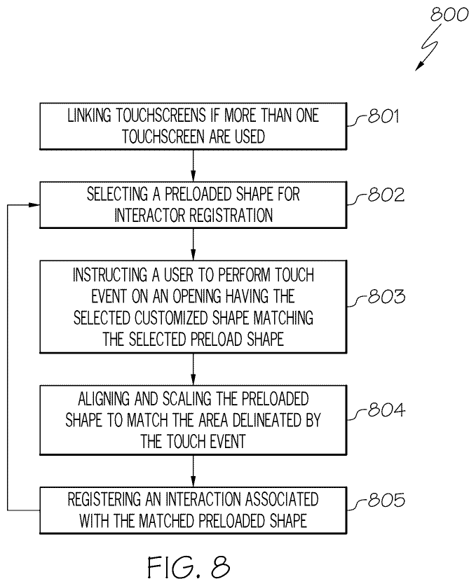

Referring to FIG. 8, an example flow diagram of illustrative registration steps for the touchscreen-based haptic controller is illustrated. At block 801, the method 800 of registration for the haptic controller based on touchscreen may include linking touchscreens, such as the App touchscreen 101 and the controller touchscreen 311 in FIGS. 3A and 3B, if more than one touchscreens are used. In some embodiments, the second touchscreen 311 may be operably linked to the touchscreen 101 by sharing an identifying code between the second touchscreen 311 and the touchscreen 101.

At block 802, the method 800 of registration may include selecting a preloaded shape 237 for interactor registration. For example, the preloaded shape 237, such as the preloaded bar shape 413 or the preloaded ring shape 513, may be selected through interaction with the controller region 115. The preloaded shape 237 and the customized shapes may include a bar shape, a heart shape, a square shape, a rectangular shape, a ring shape, a circle shape, or a combination thereof

At block 803, the method 800 of registration may include instructing a user to perform a touch event on an opening 131 having a customized shape matching the selected preload shape. For example, the preloaded shape 237, such as the preloaded bar shape 413, or the preloaded ring shape 513 may be selected and displayed in the controller region 115 for the user to register a corresponding customized shape of an opening 131, such as the bar-shape opening 131a and ring-shape opening 131c as in FIGS. 4A-5B.

At block 803, the method 800 of registration may include aligning and scaling the preloaded shape 237 (e.g., the preloaded bar shape 413 or the preloaded ring shape 513 in FIG. 4A-5B) to match the area delineated by the touch event. In some embodiments, the touch event may be detected by sensing activated pixels on the touchscreen surface and determining a pattern of the touch event. The pattern of touch event may include tapping, double-tapping, swiping, dragging, dropping toggling clockwise, and toggling counterclockwise.

At block 804, the method 800 of registration may include aligning and scaling the preloaded shape 237 to match the area delineated by the touch event. At block 805, the method 800 of registration may include registering an interaction associated with the matched preloaded shape 237.

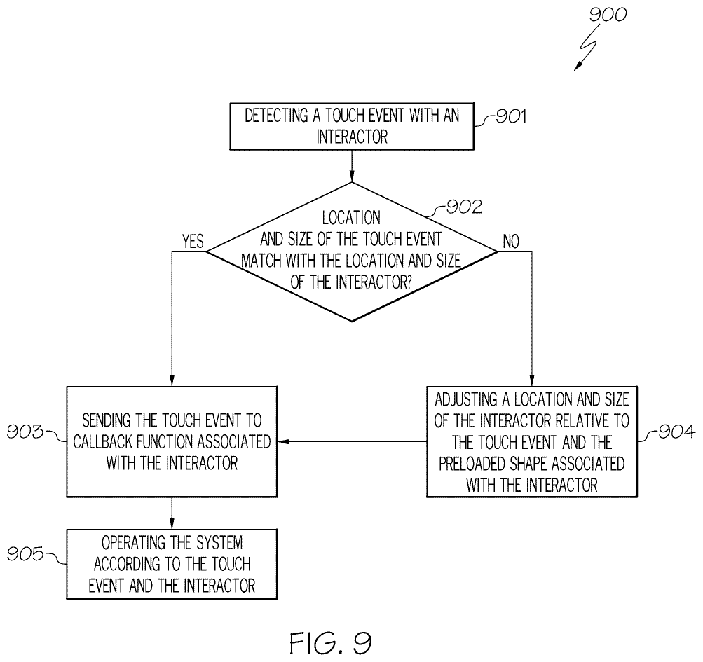

Referring to FIG. 9, an example flow diagram of illustrative deployment steps for the touchscreen-based haptic controller application is illustrated. At block 901, the method 900 of deployment for the haptic controller based on a touchscreen may include detecting a touch event with an interactor. In some embodiments, the touch event may be detected by sensing activated pixels on the touchscreen surface and determining a pattern of a touch event. The pattern of touch event may include tapping, double-tapping, swiping, dragging, dropping toggling clockwise, and toggling counterclockwise.

At block 902, the method 900 of deployment may include determining whether the location and size of the touch event match with the location and size of the interactor. If the answer to block 902 is a yes, at block 903, the method 900 of deployment may include sending the touch event to the callback function 227 associated with the interactor. If the answer to block 902 is a no, at block 904, the method 900 of deployment may include adjusting a location and size of the interactor relative to the touch event and the preloaded shape 237 associated with the interactor, and further move to block 903.

In some embodiments, the touch event may including detecting with one of the one or more interactors by detecting a location and activated pixels of the touch event, determining whether the activated pixels match with one of the one or more preloaded shapes 237 (e.g. the preloaded bar shape 413 or the preloaded ring shape 513) associated with a corresponding interactor that has a registered location different than the location of the touch event, and in determining that the activated pixels match with the one of the one or more preloaded shapes 237, assigning a location of the corresponding interactor relative to the location of the touch event and adjusting a size of the corresponding interactor relative to the one of the one or more preloaded shapes 237.

At block 905, the method 900 of deployment may include operating the tactile touchscreen system 100 according to the touch event and the interactor. In embodiments, the operation based on the touch event and the indicator may encompass various gestures and interactions. For example, a single tap over an interactor may serve as a fundamental input, triggering actions such as selection, activation of icons or buttons, or navigation within applications. Double-tapping an interactor may facilitate zooming in or out, confirming selections, or selecting specific elements within the content. Swiping gestures over an interactor, such as a bar-shape interactor, may serve navigational purposes, enabling scrolling through pages or screens, or facilitating the deletion of items through lateral movements. Clockwise or counterclockwise touches over an interactor, such as a ring-shape interactor, may trigger rotational actions or zoom functionalities, in tasks involving image manipulation or precise adjustments. Moreover, a long-press gesture may provide access to secondary menus or enable drag-and-drop functionalities for seamless organization or transfer of items. Multi-touch gestures may allow for intuitive interactions like two-finger swipes for horizontal or vertical scrolling, pinch gestures for zooming in or out, and two-finger taps for accessing contextual menus or executing secondary functions.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

It should also be understood that, unless clearly indicated to the contrary, in any methods claimed herein that include more than one step or act, the order of the steps or acts of the method is not necessarily limited to the order in which the steps or acts of the method are recited.

It is to be understood that the embodiments are not limited in their application to the details of construction and the arrangement of components set forth in the description or illustrated in the drawings. The invention is capable of some embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

1. A system for a haptic controller comprising:
a touchscreen comprising a touchscreen surface;
a stencil comprising one or more openings having customized shapes, wherein each customized shape is associated with one of the one or more preloaded shapes, and the stencil is attached to the touchscreen surface; and
one or more processors operable to:
detect a touch event with one of one or more registered interactors on the touchscreen surface, wherein each registered interaction is associated with one of the one or more preloaded shapes; and
operate the touchscreen according to the touch event and the one of the one or more registered interactors.

2. The system of claim 1, wherein the one or more interactors are registered by matching the customized shapes against the one or more preloaded shapes.

3. The system of claim 2, wherein the interactor registration comprises:
instructing a user to contact the touchscreen surface exposed through one of the one or more openings and trace an outline of an inner part of the one of the one or more openings;
detecting a registration touch event that activates a plurality of pixels of the touchscreen surface;
determining whether a shape of the activated pixels matches with one of the one or more preloaded shapes; and
registering an interactor associated with a matched preloaded shape.

4. The system of claim 2, wherein the matching comprises a scale and rotation invariant matching.

5. The system of claim 1, wherein detecting the touch event comprises sensing activated pixels on the touchscreen surface and determining a pattern of touch event.

6. The system of claim 5, wherein the pattern of touch event is tapping, double-tapping, swiping, dragging, dropping toggling clockwise, or toggling counterclockwise.

7. The system of claim 1, wherein detecting the touch event with one of the one or more interactors comprises:
detecting a location and activated pixels of the touch event;
determining whether the activated pixels match with one of the one or more preloaded shapes associated with a corresponding interactor that has a registered location different than the location of the touch event; and
in determining that the activated pixels match with the one of the one or more preloaded shapes, assigning a location of the corresponding interactor relative to the location of the touch event and adjusting a size of the corresponding interactor relative to the one of the one or more preloaded shapes.

8. The system of claim 1, wherein the customized shapes comprise a bar shape, a heart shape, a square shape, a rectangular shape, a ring shape, a circle shape, or a combination thereof.

9. The system of claim 1, wherein the system further comprises a conductive fabric arranged between the stencil and the touchscreen, wherein:
the conductive fabric comprises one or more fabric openings near locations of the one or more openings;
at least partial conductive fabric is exposed through the one or more openings;
at least partial touchscreen surface is exposed through the one or more fabric openings and the one or more openings; and
the conductive fabric is configured to detect the touch event.

10. The system of claim 1, wherein the touchscreen surface comprises an app region and a controller region, wherein the stencil is operably attached to the app region to generate interactors, and the controller region is configured to perform interactions with a user independent from the stencil.

11. The system of claim 1, wherein the system further comprises a second touchscreen operably linked to the touchscreen, the second touchscreen comprising a controller.

12. The system of claim 1, wherein the one or more processors are operably to assign an optional label to each registered interactor.

13. A method for a haptic controller comprising:
matching a customized shape of one of one or more openings against one or more preloaded shapes on a stencil-attached touchscreen surface of a touchscreen to register an interactor associated with one of the one or more preloaded shapes that matches the customized shape;
detecting a touch event with the registered interactors; and
operating according to the touch event and the registered interactors; and
wherein the stencil comprises the one or more openings having one or more customized shapes.

14. The method of claim 13, wherein the interactor registration comprises:
instructing a user to contact the touchscreen surface exposed through one of the one or more openings and trace an outline of an inner part of the one of the one or more openings;
detecting a registration touch event activating a plurality of pixels of the touchscreen surface;
determining whether a shape of the activated pixels matches with the one of the one or more preloaded shapes;
registering the interactor associated with a matched preloaded shape; and
wherein the matching comprises a scale and rotation invariant matching.

15. The method of claim 13, wherein detecting the touch event comprises:
sensing activated pixels on the touchscreen surface and determining a pattern of touch event, the pattern of touch event comprising tapping, double-tapping, swiping, dragging, dropping toggling clockwise, and toggling counterclockwise.

16. The method of claim 13, wherein detecting the touch event with the registered interactors comprises:
detecting a location and activated pixels of the touch event;
determining whether the activated pixels match with one of the one or more preloaded shapes associated with a corresponding interactor that has a registered location different than the location of the touch event; and
in determining that the activated pixels match with the one of the one or more preloaded shapes, assigning a location of the corresponding interactor relative to the location of the touch event and adjusting a size of the corresponding interactor relative to the one of the one or more preloaded shapes.

17. The method of claim 13, wherein the customized shapes comprise a bar shape, a heart shape, a square shape, a rectangular shape, a ring shape, a circle shape, or a combination thereof.

18. The method of claim 13, wherein the method further comprises arranging a conductive fabric between the stencil and the touchscreen, wherein:
the conductive fabric comprises one or more fabric openings near locations of the one or more openings;
at least partial conductive fabric is exposed through the one or more openings;
at least partial touchscreen surface is exposed through the one or more fabric openings and the one or more openings; and
the conductive fabric is configured to detect the touch event.

19. The method of claim 13, wherein the touchscreen surface comprises an app region and a controller region, wherein the stencil is operably attached to the app region to generate interactors, and the controller region is configured to perform interactions with a user independent from the stencil.

20. The method of claim 13, wherein the method further comprises linking the touchscreen to a second touchscreen comprising a controller.
